(19) United States
(12) Patent Application Publication
(10) Pub. No.: US 2018/0075634 A1
(43) Pub. Date: Mar. 15, 2018

(54) System and Method of Generating an Interactive Data Layer on Video Content

(71) Applicant: AHIM KANDLER, NES ZIONA (IL)

(72) Inventor: AHIM KANDLER, NES ZIONA (IL)

(21) Appl. No.: 15/701,500

(22) Filed: Sep. 12, 2017

Related U.S. Application Data
(60) Provisional application No. 62/393,193, filed on Sep. 12, 2016.

(51) Int. Cl. G06T 11/60

(52) U.S. Cl. CPC G06T 11/60

(57) ABSTRACT

The invention represents an interactive 360-degree media player that allows end users to communicate among each other about the spherical content right on top of the imaging. This is achieved by creating a real-time communication layer that is managed independently from the image source. User can only exchange information in real-time, but are also able to tag their information elements to specific time points and spherical coordinates in the communication layer. For this purpose the invention creates an internal spherical coordinate system both for the data layer and for the imaging layer, which are synchronized and coordinated between clients and servers and thereby also among a multitude of users.

### CROSS-REFERENCE TO RELATED APPLICATIONS

A provisional patent application titled “System and Method of Generating an Interactive Data Layer on Video Content” was filed on Sep. 12, 2016 with application No. 62/393,193.

### BACKGROUND OF THE INVENTION

When viewing 360° content (for example a 360° video) a viewer is able to see only a section of the surroundings. The reason for this is that a human being has a field of view limited to less than 180 degrees, and in many circumstances we are able to observe what happens only inside an angle of 120 degrees. This means that when we watch a 360° video (also called a spherical video), we are missing things behind us, just like in real life. A viewer, therefore, needs to “rewind” and re-watch the video multiple times in order to see as much as possible around 360° at every point in time.

While spherical videos are interesting as they convey a feeling of “teleportation”, they can be frustrating to watch due to the reason explained above: viewers need to go back and forth in time and actively pan around horizontally and vertically in order to understand the video and in order to see as much as possible. Most consumers would not want to invest so much time in watching a spherical video—as interesting as it may be. This is also based on my own experience in working with spherical and panoramic content for many years.

The invention would make watching spherical videos easier, simpler, faster and more fun. And it would allow individual users to add comments to the video so that they could tell other people who would later watch the video what they had found in the video to be interesting. Subsequent viewers could then use these comments as a basis for their own exploration of the spherical video. The invention allows a viewer not only to add textual input, but it allows its users to add any content from text to drawings and graphics to stills and other rich media. And the invention makes this experience interactive where content “posted” would be available instantly to other users who would watch the video. The invention leaves the original video file as is. It captures, manages and stores the information generated by users on the video on a data layer independently from the video. What is more, it allows a viewer to pin their “posting” to a specific longitude and latitude inside the video (like the name of a country on top of a world globe) instead of working with the traditional “global” comments and likes that people would put on the video as a whole or write below the video. These are referred to as data layer coordinates. The invention also adds a way for viewers to pin their content to a data layer coordinate at a specific point in time because then others can relate these postings to a specific point in the video which helps everybody watching the video get a better overview and be able to navigate in the video between user-generated points of interest.

I found that what works for spherical video content would also be a perfect enhancement of two-dimensional video. In two-dimensional video there would not be data layer coordinates around 360° vertically and horizontally, but it would nevertheless be possible to work with a similar set of coordinates to map a data layer on top of a two-dimensional video.

The invention also gives its users the possibility to select or pin-point specific objects in the video and then track these objects. This would be especially useful for objects that do not remain static in a video but tend to move around. Therefore, the invention adds conventional (where possible) video analytics tools and algorithms to analyze for example motion and objects and makes this data available to the data layer so that viewers would be able to post content which would move along with the object.

### BRIEF SUMMARY OF THE INVENTION

Various aspects of the invention may have, but are not limited to, one or more of the following advantages:
Spherical video will become more interesting as viewers are able to interact on top of the video, “inside” the video content in real time.
Information added by one user to a data layer becomes available and visible to other users instantly which allows communication between multiple users that are viewing the video simultaneously.
The information posted by the users is not “baked” or added into the video file itself. It remains unmodified and does not carry the information exchanged between the users. This means video files need to be downloaded or streamed only once to a device. The exchange of information between users in the data layer is done through a separate communication protocol.
Users are able to add any content “on top of” the video, such as text, images, graphics, drawings, audio, video, photos; the invention allows adding any rich media.
Information that users add to the data layer is connected to a specific coordinate of the video which means that one user knows how the visual content added by another users is related to the content of the video.
In the case of incorporating information provided through a video analytics tool, a user will be able to tag objects (e.g., persons) in the video and be able to visually follow them throughout the video, while being able to add content to the tag. Think in terms of a basket ball or soccer match in television where users can add tags to the players that follow these players and have content such as text, messages, chats, and even graphical content attached to the tag follow the player.
Information in the data layer is exchanged in real time.
The invention works with any 2D, 3D, and spherical video format and file.
It does not require using dedicated gear like for example virtually reality headsets.
It is platform independent and can, for example, be implemented on mobile devices, personal computers, gaming consoles, smart TVs, control systems, video post-processing systems, and set-top boxes.

### BRIEF DESCRIPTION OF THE DRAWINGS

FIG. 1 is a view of the data layer as an equi-rectangular projection of a sphere on a flat surface (similar to the projection of the earth globe on a two-dimensional map).

FIG. 2a is an illustration of a perspective view of the data layer corresponding to a spherical video content.

FIG. 2b illustrates how the transparent or semi-transparent data layer is overlapped with the spherical video content.

FIG. 3 is an illustration of a section of a data layer that overlaps a spherical video with the field of view through a mobile device as an example.

FIG. 4 is a description of the steps that are processed on the user's device and how they related to the remote process on a server or other backend platform.

FIG. 5 is an illustration of a data point with tracker in which a data point moves with an object from video frame to video frame. The figures shows an example of a data point tagged to a person, moving along with its information through four subsequent video files, following the person while it is running.

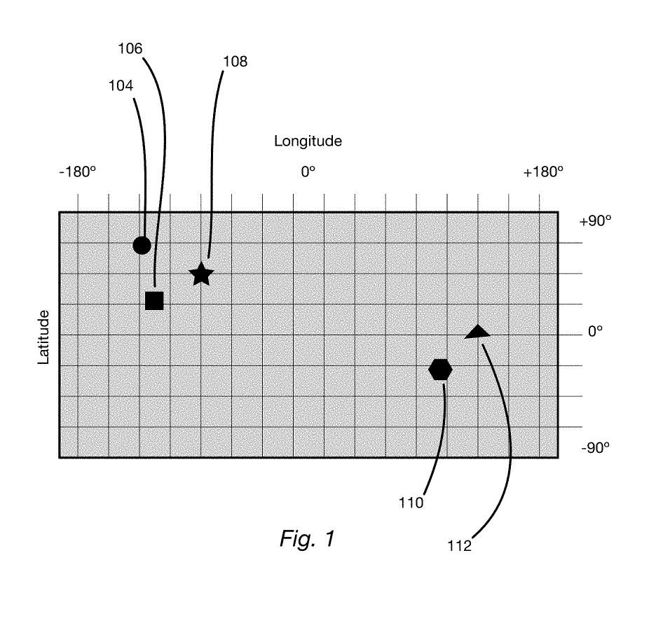

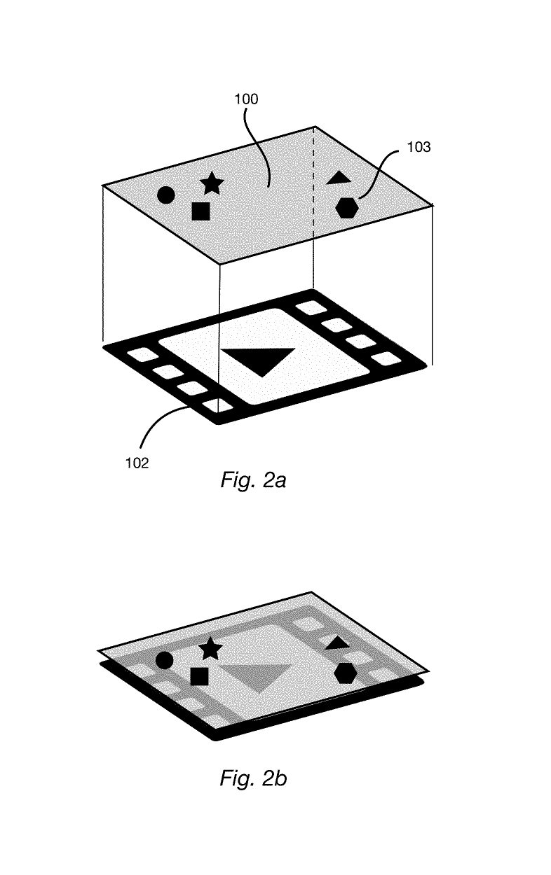

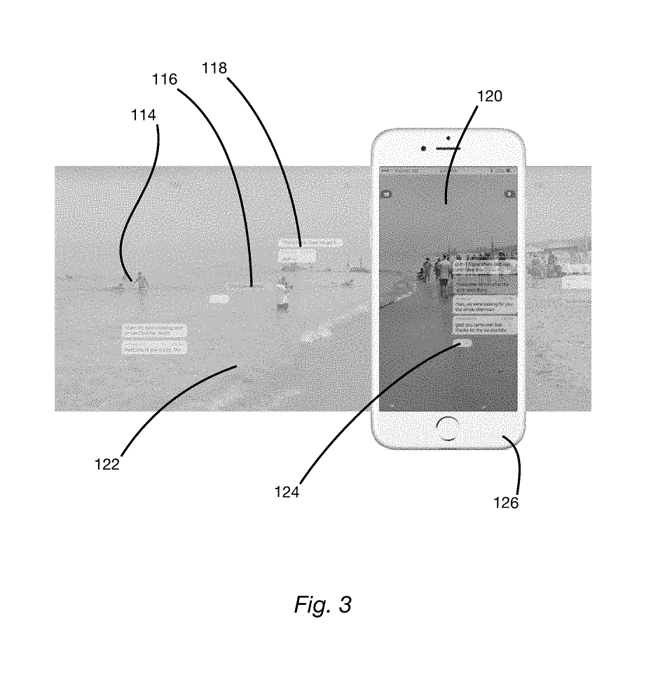

A transparent or semi-transparent spherical data layer with coordinates as shown in FIG. 1 contains several independent data points 104, 106, 108, 110 and 112, which represent inputs added by the same and/or a plurality of users; these data points are located at different coordinates in the data layer. In FIG. 2a, the independent data layer 100 has multiple non-transparent or semi-transparent data points 103 (as in FIG. 1) which are, together, overlaid on a corresponding spherical video content 102 as shown in FIG. 2b. The data points 114, 116 and 118 in FIG. 3 represent examples where one or more users have added text input pinned to specific coordinates on top of the spherical video 122. Data points added by other users 124 appear live on the spherical video being watched by the user. Users merely see a section of a spherical video at a time through a field of view 120 (a window to the spherical world) determined by the network-enabled mobile device that contains a processing unit 126.

Data layers may include tagged data points 130 that move with certain objects seen in the video, rather being statically attached to a coordinate and a time; these objects are being “tagged” or “tracked” by a video analytics tool so that the information in the data point 131 can move along with the object 138. The data points 132, 134 and 136 represent the same data point 130, but in subsequent frames, i.e. specific points in time after the object has first been “tagged” or selected for “tracking”.

### DETAILED DESCRIPTION OF THE INVENTION

The invention is based on a method for generating a data layer corresponding to a two-dimensional, 3D or spherical video content. The data layer may include user-generated content and may be stored on a dedicated server to be viewed in combination with the video content by a plurality of users. The data layer is configured in coordinates, or more specifically in the coordinates of the video content, such that a data point in the data layer marks a specific location in the video content and may be moved together with the displayed portion of the video content within the user's screen.

Today, spherical video is played back through online video players provided for example through Youtube or Facebook. These players simply play back a video, allowing a user to pan around 360° using a touch screen or a mouse or another input device. These platforms allow users to interact on the media that they upload using the standard tools provided by these platforms. These standard tools work for photos and normal videos and allow a user to write comments and replies to comments and add “likes” and similar interaction on a timeline or around or beneath the media that was uploaded. Mobile platforms like Snapchat use an image or a video created by a user and allow a user to add visual effects to the media, like for example a tongue, a rainbow and other graphics that modify the original photo or video and create a new photo or video that incorporates the added visual effects on the level of the video. Snapchat, for example, may be working on a feature that would allow adding those same visual effects not just on normal photos and videos, but also on spherical video.

In another case, Youtube, for example, allows users to add banners and links, while Youtube itself adds advertisements on top of the video or the spherical video. These are, however, added on a global level, affecting the whole video.

The invention is different from these platforms in that it does “augment” spherical video with a data layer containing visual information that is overlaid on top of the spherical video (but not merged with the video), without having to modify the spherical video itself and without having to create a new spherical video out of the original one. The data layer and the spherical video are two separate entities. The information exchanged in the data layer is synchronized in real time with a server or cloud-based back-end platform. The information in the data layer can be generated by one user or by a multitude of users. Because it connects the communication from a multitude of users through a real-time data layer, these users can, for example, communicate among them in an instant-messaging-like chat. As the data layer is transparent or semi-transparent, the interaction among users is displayed on top of the spherical video. As the data layer corresponds to the video, it is also of spherical nature. The data layer has coordinates that spread around 360° horizontally and vertically. This is similar to a world map with a longitude from −180 degrees to +180 degrees and a latitude from −90 degrees to +90 degrees. While watching a video, users can, for example, add visual information by pressing a button, clicking a mouse or tapping a touch screen. In which case, the information they are adding is linked to these specific data layer coordinates of this location. This information is saved as part of the data layer and transmitted to the backend. The backend gathers information from users on the videos they are using. This way it is possible to load one user's data layer with the information that was added by other users on the same video.

The information that users can add to the data layer includes but is not limited to: text, drawings, graphics, symbols, emojis, photos, videos, audio.

Therefore, the process of using an “augmented” data layer with spherical video means that users can create content in the data layer (which is synchronized with the backend), they can receive content created by a backend process (for example advertisements) in the data layer, and they can receive/see content created by other users in the same data layer.

The image files, whether they represent videos, photos or computer-generated graphics, assuming they are or were tagged to a geographical coordinate of the earth, can be organized in the backend in a way such that users can search, filter and retrieve image content by geographical location.

While the data layer corresponds with the video in the spherical dimensions (overall longitude and latitude of the video), the data layer does not have to match the video in terms of the frame rate. In other words, the data layer may have a different frame rate than the video, which can be a fraction or a multiple of the frame rate of the video.

Imagine the result of the combination of the data layer with spherical video content as two independent imaginary displays. The one at the bottom represents the spherical video and it is not transparent. The second display is transparent and placed on top of the first one. As the second display itself is transparent like glass, the information displayed on it will be overlaid with the spherical video on the lower, first display.

Here is an example of how it may work on a mobile device, for example. A user would load a spherical video and start to view it. During the viewing experience, the users could interact with the application and initiate a process that would allow them to add text or other rich content at a specific coordinate. Once they entered the information, this information would be displayed on top of the video imaging linked to the coordinates the information was supposed to be linked with.

This process can be repeated unlimited times for a spherical video by users. Users can choose to share the spherical video with the data layer (which we call an augmented spherical video) with other users. In this case other users will also be able to add their own content to the data layer which will then be shared with users to whom the video was shared.

Sharing is an important feature of today's social networks, but the invention is not dependent on the ability to share it with other users. The data layer on a spherical video also works as a standalone application without being connected to a network.

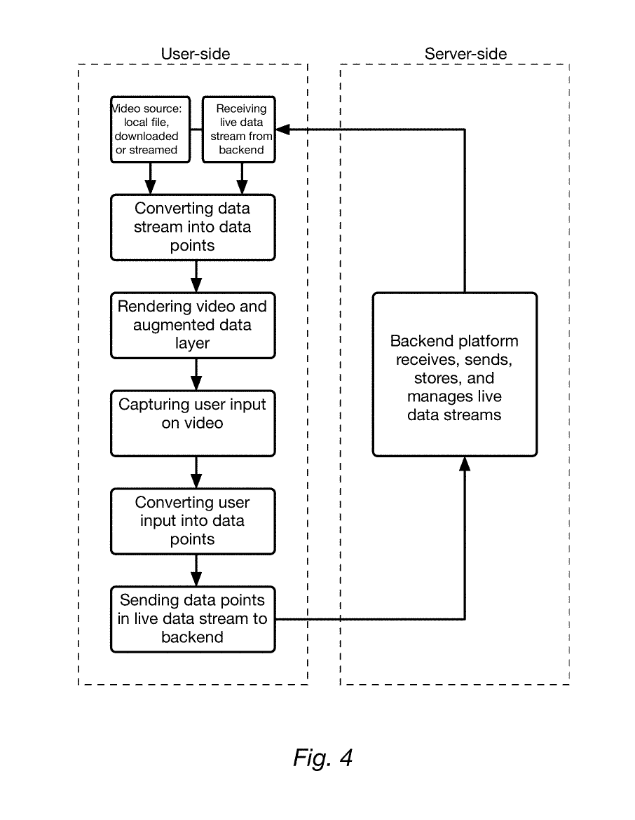

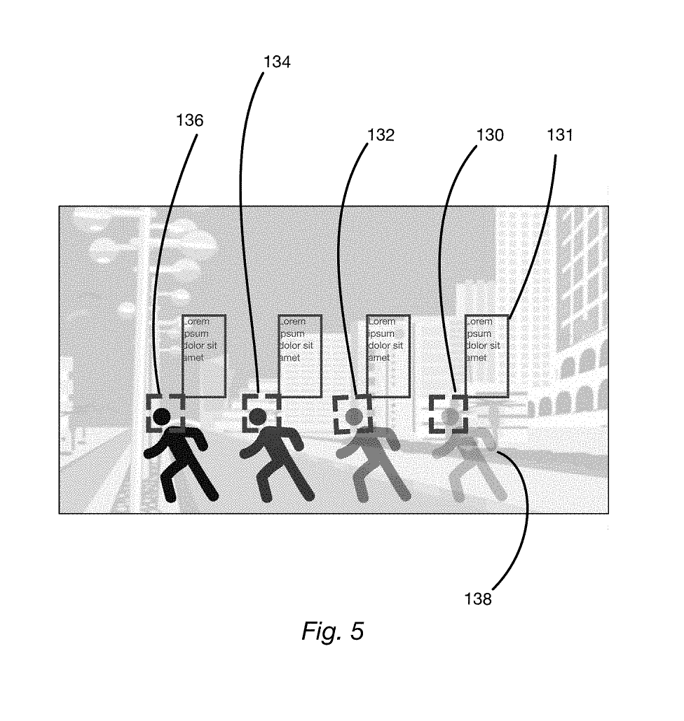

In the case of an implementation of the invention with a network-enabled mobile device, there is a user-side process and a back-end side process, which is described in FIG. 4. On the user-side the data layer needs to receive a live data stream from the backend. This live stream contains data that needs to be incorporated into the data layer, but it needs to be converted into data points, as the information added by the users is linked to a specific longitude, latitude and time of the spherical video. In a next step, these data points are loaded into the data layer which is then visually rendered as an overlay of visual information on top of spherical video. This can be accomplished using the graphical processing unit (GPU), central processing unit (CPU) or similar processing unit capable of running OpenGL or similar rendering technologies, such as Apple's Metal framework, or gaming engines like Unity and Unreal. The processing can take place locally on the device or remotely on a server or in the cloud.

Spherical video means users can merely see a section of the whole sphere at a given time. Therefore users have to pan around the sphere to look into different directions. While users pan around the video, it is important to understand that the information in the data layer is rendered visually in such a way that it is “pinned” to a specific longitude and latitude of the video. That means that while panning around in the video, the information contained in the data layer will also move around with the video to which is was “pinned”. Data points that are linked to spherical video coordinates that are currently not in the selected visible field of view may not get displayed. Data points linked to a data layer coordinate that is currently visible will also be visible at the respective video coordinate; but users may choose to hide data points even though they are currently in the visible field of view.

Independently of whether a spherical video that a users views already contains or does not contain data points in the data layer, users can now add information on top of the video and link it to a specific data layer coordinate. This user input is now converted into a data point, which is part of a data layer and contains information entered by a user together with the coordinates of the spherical video to which this information is linked to.

These data points are sent to the backend instantly after they were created in a live data stream from the mobile device to the backend. The backend receives such data streams from a plurality of users and devices. It stores and manages these data points and the spherical videos, and re-sends the data points to users thereby allowing users to have access to data points instantly after the creation by its users.

Another uniqueness is that the coordinates of the data points can be dynamically updated by a video analysis tool that keeps track of the location of an object in the video frames and reports the changing location of the object to the data layer which in turn moves the information with the location of the object, hereby tagging the object in the video with the information contained in the data point.

This is especially useful for two-dimensional video which is broadly available through online video aggregation platforms and which can be created easily on many devices, including mobile devices. In the case of online video platforms videos are accessible through unique URLs for a specific video, which means we do not have to download or import the video; instead, we could stream the video from the platform each time it is requested and just add our data layers on top of the video on the fly. This way, we do not need to store the video on our servers/backend; we could opt to merely store the information in the data layers on our backend, thereby saving storage space as an additional benefit.

I would like to point out that the data layers described above cannot be implemented using available video players; the augmentation of 2D, 3D and 360° video with data layers requires a dedicated application (whether mobile, web or embedded) specifically tasked for the purpose of combining data layers with underlying video content and, optionally, integrating video analytics tools that provide additional information about the video to the data layer.

### ALTERNATIVE EMBODIMENTS

There are alternative ways of embodying the invention which can also be thought of as an interactive 360-degree media player as described below:
The data layer can also be used on top of two-dimensional video, still images, spherical stills, panoramic videos and stills, as well as computer-generated graphics like games, in which case the data layer's range of coordinates will be adapted to match the size and field of view of the two-dimensional video.
Different video formats can be used as the underlying spherical video.
The spherical video does not have to be in the form of an encoded video file (e.g. MPEG, H264), rather it may be a sequence of still images (moving images).
The spherical video does not have to be in the form of a file. It could also be in the form of a video stream—for example a live video stream or a stream from a third party video aggregation platform such as Youtube accessible through a URL.
In lieu of mobile devices other platforms could be used, such as game consoles, set-top boxes, smart televisions, personal computers, laptops, tablets.
One mode is to implement it in a mobile application. Other modes include implementation in a web app or in any form of an embedded app, or in the form of an API or SDK.
Another mode is generating data layers in a standalone, offline application without exchanging data points in real time.
The information contained in data layers may be incorporated into meta data of the video file.
The information contained in data layers may be graphically embedded into the video content itself, for example for “exporting” augmented spherical video into conventional video that can be uploaded and played back on platforms like Youtube and Facebook.
Video analytics tools such as face recognition, search, video motion detection, object tracking and tagging, may be incorporated and provide additional information about content in the video to the data layer.
In an additional embodiment, data points could be combined with algorithms that track an object. Tracking algorithms and video motion detection algorithms are well known in security and surveillance software and systems. State-of-the art video analysis algorithms or proprietary video analysis algorithms can be used as plug-ins to the data layer. What is unique is the combination of a video analysis tool analyzing the underlying video source and communicating the coordinates of the object being tracked across video frames to the data layer which combines this information with the information contained in the data points thereby generating a data point that is not statically attached to a fixed coordinate, but whose coordinates are constantly being updated by the tracking tool to allow the data point move along with the object being tracked. The tracking tool could be activated automatically by a backend process. It could also be activated by a user, for example by double-clicking an object or by selecting an area on top of the video image.

1. System and method of generating 360-degree video content augmented with an overlay of communication elements that can be shared among a plurality of users as a unique 360-degree media format, where:
1.1. data elements in the data layer are generated by users on their front-end devices (for example on the client side);
1.2. data elements in the data layer are exchanged (“synchronized”, “updated”) among a plurality of end user devices in real time;
1.3. the data layer and/or the video layer are or can be tagged to a geographical coordinate (longitude, latitude) of the earth;
1.4. the data elements are overlaid (“augmented”) over the video layer without themselves becoming a part of the video file/layer, or at least without modifying the original pixels in the video file.
1.5. the data layer can be used in connection with a live preview of a video (“live video”, “live streaming”) and with a previously recorded video file (for example “video on demand”);
1.6. the data layer can be used in full spherical videos, panoramic videos, and in partly spherical videos that represent a fraction around 360-degrees, whether horizontally or vertically.

2. System and method of generating 360-degree photo (stills) content augmented with an overlay of communication elements that can be shared among a plurality of users as a unique 360-degree media format, where:
2.1. data elements in the data layer are generated by users on their front-end devices (for example on the client side);
2.2. data elements in the data layer are exchanged (“synchronized”, “updated”) among a plurality of end user devices in real time;
2.3. the data layer and/or the photo layer are or can be tagged to a geographical coordinate (longitude, latitude) of the earth;
2.4. the data elements are overlaid (“augmented”) over the photo layer without themselves becoming a part of the photo file/layer, or at least without modifying the original pixels in the image file.
2.5. the data layer can be used in full spherical photos, panoramic photos, and in partly spherical photos that represent a fraction around 360-degrees, whether horizontally or vertically.

3. System and method of generating 360-degree computer-generated imaging (“CGI”) (like in games or in computer aided engineering) augmented with an overlay of communication elements that can be shared among a plurality of users as a unique 360-degree media format, where:
3.1. data elements in the data layer are generated by users on their front-end devices (for example on the client side);
3.2. data elements in the data layer are exchanged (“synchronized”, “updated”) among a plurality of end user devices in real time;
3.3. the data layer and/or the CGI layer are or can be tagged to a geographical coordinate (longitude, latitude) of the earth;
3.4. the data elements are overlaid (“augmented”) over the CGI layer without themselves becoming a part of the CGI file/layer, or at least without modifying the original pixels in the CGI file.
3.5. the data layer can be used in full spherical CGI, panoramic CGI, and in partly spherical CGI that represent a fraction around 360-degrees, whether horizontally or vertically.
